(19) United States
(12) Patent Application Publication
(10) Pub. No.: US 2003/0058835 A1
(43) Pub. Date: Mar. 27, 2003

(54) Cross-connect control apparatus and method for broadband digital cross-connect system

(75) Inventor: Hyun-Sang Cho, Incheon (KR)

Correspondence Address: FLESHNER & KIM, LLP, P.O. Box 221200, Chantilly, VA, 20153-1200, US

(73) Assignee: LG Electronics Inc.

(21) Appl. No.: 10/234,470

(22) Filed: Sep. 5, 2002

(30) Foreign Application Priority Data
Sep. 21, 2001 (KR) 58761/2001

(51) Int. Cl. H04L 12/28

(52) U.S. Cl. 370/351

(57) ABSTRACT

In a B-DCS (broadband digital cross-connect system) having plural input/output ports, a cross-connect control apparatus for a B-DCS includes a cross-connect signal generating unit which generates signals for setting cross-connects based on input cross-connect commands, and a switching unit installed at the output ports for establishing a cross-connect between an input port and an output port according to cross-connect signals from the cross-connect generating unit. A cross-connect control method for a DCS (digital cross-connect system) includes receiving a cross-connect command; generating an input/output port address and a connect/release request signal according to the cross-connect command; transmitting an input port address to be connected to each output port; generating an enable signal (W_EN) indicating a cross-connect setting between the output port and the input port; judging whether the output port is in a preset cross-connect state based on the enable signal; generating an error message when the output port is in the preset cross-connect state; and establishing cross-connect between the output port and the input port when the output port is not in the preset cross-connect state.

### BACKGROUND OF THE INVENTION

1. Field of the Invention

The present invention relates to a B-DCS (broadband digital cross-connect system), and more particularly to a cross-connect control apparatus and method which are capable of preventing cross-connect errors in advance, for example, by detecting preset cross-connect information when a cross-connect is newly set in a switch used for a B-DCS.

2. Background of the Related Art

One type of B-DCS (broadband digital cross-connect system) is a SONET DCS which cross-connects signals such as a DS-3, a STS-1 and a STS-3c, etc. In a B-DCS of this type, a space switch switches only an input signal and does not control signal elements in the signal. In general, because of the basic characteristics of the switch, it is impossible to simultaneously connect plural input ports to one output port. If several input ports are connected to one output port, an error will occur in the output signal.

In a conventional cross-connect mechanism, when a cross-connect command relating to a new input port is input to an output port in a preset cross-connect state, the previously set cross-connect is cut off and new cross-connect is set. Accordingly, when a wrong cross-connect command is input, errors may occur in the DCS.

FIG. 1 is a block diagram illustrating the conventional DCS. As shown, the conventional DCS includes a signal line interface 110 connected to a DS-N and a STM-N signal transceiver lines; a circuit distribution unit 120 for classifying-distributing DS-N and VC-N signals inputted/outputted through the signal line interface 110; a synchronizing unit 140 for synchronizing the system; a memory unit 150 for storing data processed in the circuit distribution unit 120; an operating terminal 160 for operating the system by providing an interface between an operator and the system; and a main control unit 130 for controlling the construction units.

FIGS. 2a and 2b are diagrams illustrating an input-output port connect setting process of the conventional DCS. As shown, in a cross-connect state between an output port_A and an input port_A, when a cross-connect setting command is input from an input port B to the output port _A, the cross-connect between the output port_A and the input port_A is released, and the input port_B and the ouput port_A are cross-connected. More specifically, in the conventional DCS, when a cross-connect command is input from another input port, regardless of the existing cross-connect state, a cross-connect is newly set according to a new cross-connect setting command.

However, in the conventional cross-connect mechanism, when a cross-connect is newly set as a result of an input error, a resetting command may be applied to the existing set output port. When th is occurs, a service processed in the output port may be interrupted.

In order to prevent the service interruption due to a cross-connect command, a cross-connect can be controlled by a software-like method. In this case, however, because a connect state of an actual apparatus may be different from software-like connect information, close attention is required for establishing a new signal line cross-connect, and/or for managing the existing signal line.

### SUMMARY OF THE INVENTION

An object of the invention is to solve at least the above problems and/or disadvantages and to provide at least the advantages described hereinafter.

It is an object of the present invention to provide a cross-connect control apparatus and a method which prevents service interruption due to an input/output error of cross-connect command, by selectively executing a cross-connect command based on a state of service of a pertinent output port when a cross-connect command is input into a DCS (digital cross-connect system).

In order to achieve the above-mentioned object, a cross-connect control apparatus for a broadband digital cross-connect system (B-DCS) in accordance with the present invention includes a cross-connect signal generating unit which generates signals for setting cross-connects based on input cross-connect commands and a switching unit installed at an output port for establishing a cross-connect between an input port and the output port based on a cross-connect signal from the cross-connect generating unit.

In order to achieve the above-mentioned object, a cross-connect control method for a DCS (digital cross-connect system) in accordance with the present invention includes receiving a cross-connect command; generating an input/output port address and a connect/release request signal according to the cross-connect command; transmitting an input port address to be connected to each output port; generating an enable signal (W_EN) indicating a cross-connect setting between the output port and the input port; judging whether the output port is in a preset cross-connect state by using the enable signal; generating an error message when the output port is in the preset cross-connect state; and establishing a cross-connect between the output port and the input port when the output port is not in the preset cross-connect state.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a block diagram illustrating the conventional B-DCS (broadband digital cross-connect system);

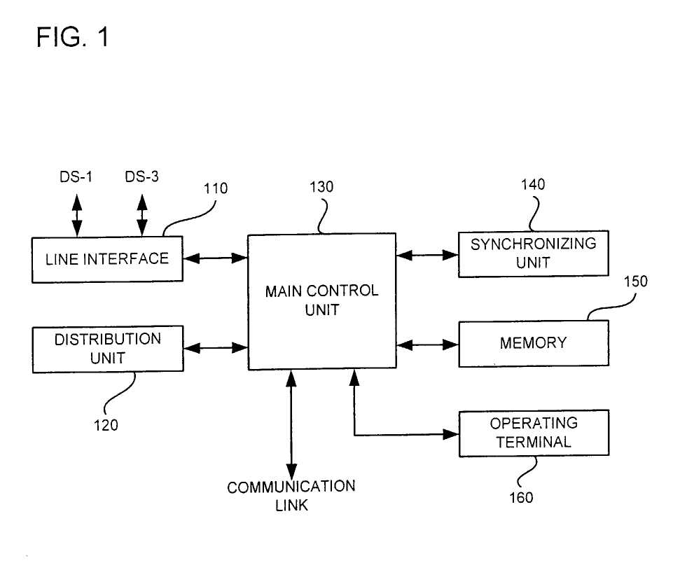

FIGS. 2a and 2b illustrate cross-connect process in the conventional B-DCS;

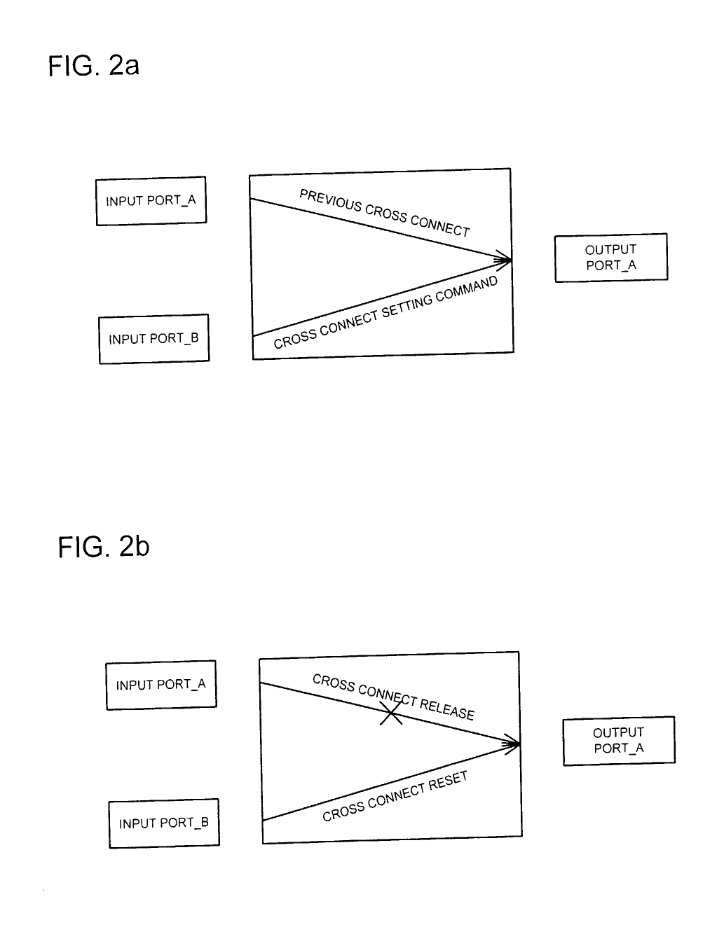

FIG. 3 is a block diagram illustrating a connect signal generating means of a cross-connect control apparatus for a DCS (digital cross-connect system) in accordance with the present invention;

FIG. 4 is a block diagram illustrating a switching means of a cross-connect control apparatus for the DCS (digital cross-connect system) in accordance with the present invention; and

FIG. 5 is a flow chart illustrating a cross-connect control method of a DCS (digital cross-connect system) in accordance with the present invention.

### DETAILED DESCRIPTION OF PREFERRED EMBODIMENTS

The embodiments of a cross-connect control apparatus and a method thereof for a B-DCS (broadband digital cross-connect system) will now be described with reference to accompanying drawings.

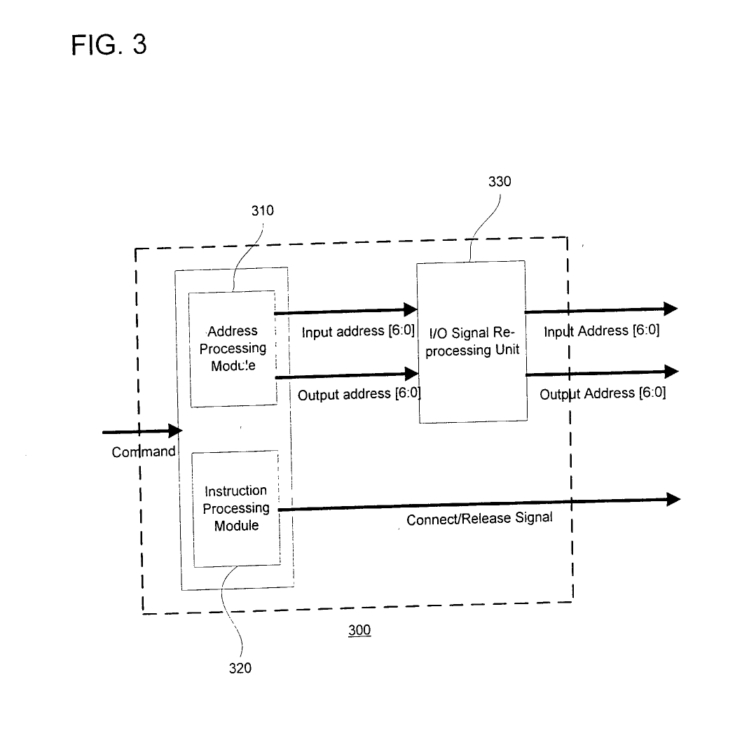

FIG. 3 is a block diagram illustrating a connect signal generating means of a cross-connect control apparatus for use within a DCS (digital cross-connect system) in accordance with one embodiment of the present invention. The cross-connect control apparatus includes a command generation unit 300 which receives a cross-connect command from an operating terminal 350, designates addresses of an input port and an output port to be cross-connected with each other, and generates a connect/release request signal. The cross-connect command is preferably generated in the operating terminal 350, however, it is not limited by that. The cross-connect command orders a cross-connect to be established between a designated input port and output port, and accordingly resetting of a previous set cross-connect state is performed.

In the present invention, three signals (an input port address signal, an output port address signal and a cross-connect enable signal) are used in order to set a desired cross-connect. In this exemplary embodiment, the cross-connect control apparatus in accordance with the present invention is applied to a non-blocking switch having ninety-six input ports and ninety-six output ports. Because there are ninety-six input ports and ninety-six output ports, in order to designate ninety-six ports, an address of each input port and output port consists of 7 bits.

As shown in FIG. 3, the command generation unit 300 includes a command processing unit 305 having an address processing module 310 and a command processing module 320, and an I/O signal reprocessing module 330.

The address processing module 310 generates an address of an input port to be connected and an address of an output port to be connected according to an input cross-connect command. Because a port address is designated by 7 bits, an input port address is constructed as ‘input address [6:0]’ and an output port address is constructed as ‘output address [6:0]’.

When the command processing module 320 receives a cross-connect command from the operating terminal 350, it transmits a connect release signal to the pertinent input port and the pertinent output port and also transmits a cross-connect signal to the input port and output port to be cross-connected with each other.

The I/O signal reprocessing module 330 generates ninety-six 7 bit address signals for selecting an input port to be cross-connected with an output port. This may be accomplished by reprocessing the input and output ports addresses generated in the address processing module 310.

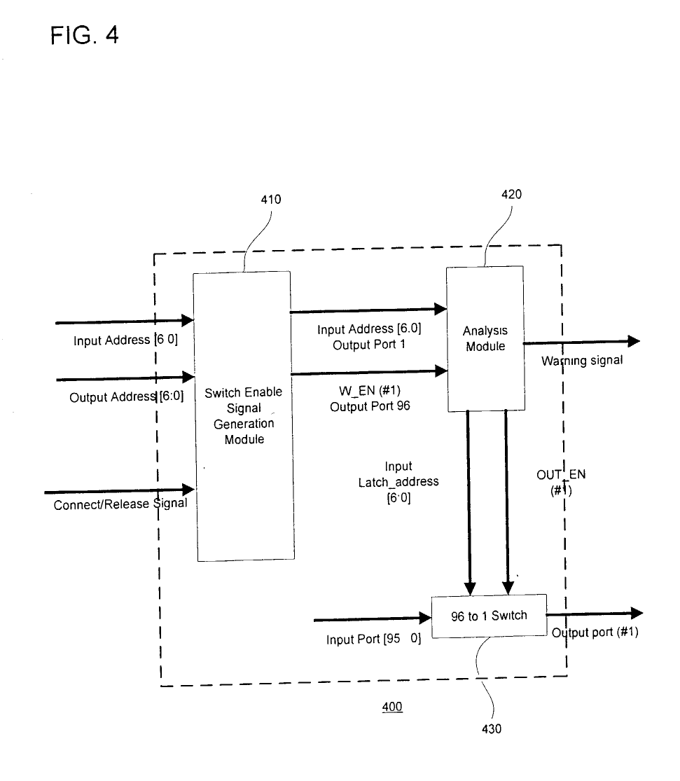

FIG. 4 is a block diagram illustrating one embodiment of a switching means 400 of the cross-connect control apparatus for a DCS (digital cross-connect system) in accordance with the present invention. Functionally, the switching means resets a cross-connect state between an input port designated by the address generated in the command generation unit 300 and a pertinent output port. Structurally, the switching means includes an enable signal generation module 410, an analysis module 420, and a switching module 430. Preferably, one switching module 430 is allocated to each output port. Because there are ninety-six output ports, an output signal generated in one command generation unit 300 is transmitted to the ninety-six switching means 400, and accordingly cross-connect of each output port is controlled.

The enable signal generation module 410 receives the connection request signal from the command processing module 320 of the command generation unit 300, respectively receives an output port address (output address [6:0]) from the address processing module 310 and an input port address (input address [6:0]) from the I/O port address reprocessing module 330 and generates an enable signal W_EN) for resetting the cross-connect. More specifically, the enable signal generation module 410 generates ninety-six enable signals (W_EN) for generating switch connect and ninety-six disable signals (D_EN) for releasing the switch connect. Accordingly, when a new connect command is applied from the command processing module 320, the enable signal generation unit 410 generates a 7 bit input port address (input address [6:0]), a 1bit enable signal (W_EN) and a 1bit disable signal (D_EN). Because the disable signal (D_EN) relates to a cross-connect release control, it will not be described in detail.

The analysis module 420 receives the enable signal (W_EN) relating to the input port designated by the input port address (input address [6:0]) output from the enable signal generation module 410 and judges whether cross-connect between the pertinent input port and the output port is possible. More specifically, when there is an existing preset connect, the analysis module 420 judges connect-disable, except that case, the analysis module 420 judges connect-enable. In the judging result, when it is judged as the connect-enable state, the analysis module 420 generates a switching control signal (OUT_EN), outputs it to the switching module 430, and controls the switching module 430.

When the OUT_EN signal is 1, according to Latch address information input from the analysis module 420, among ninety-six input ports, a pertinent port is connected with the output port. When the OUT_EN signal is 0, the output port is not connected with any input port and is set as an empty port.

The analysis module 420 compares the enable signal (W_EN) generated in the enable signal generation module 410 with the pre-stored OUT_EN signal. When it is judged as a channel in the preset cross-connect state, it generates an error signal and transmits it to the operating terminal 350 or an operation managing unit of the system. Accordingly, the operator can correct the wrong cross-connect command by referring to the error signal.

When the switching module 430 receives the OUT_EN signal indicating connect-enable between the pertinent input port and the output port from the analysis module 420, it performs switching operation for setting cross-connect between the pertinent input port and the output port. The switching module 430 is preferably constructed as a space switch in the B-DCS.

For example, in a 9696 crosspoint switch, each output port has the switching means 400. Accordingly, when a cross-connect command relating to an output port #1 is input, the enable signal generation module 410 of the switching means 400 connected to the output port #1 generates an input port address (input address [6:0]) and an enable signal (W_EN#1). When the cross-connect to the output port #1 is preset, the analysis module 420 generates an error signal, except that case, it outputs a signal (OUT_EN#1) for controlling cross-connect setting and simultaneously a latched input port address (input Latch_address [6:0]) to the output port #1. The switching module 430 receives the control signal (OUT_EN#1) from the analysis module 420, and among its ninety-six input ports ([95:0]), it connects an input port designated by the latched input port address (input Latch_address [6:0]) with the output port #1, and accordingly the cross-connect setting is performed.

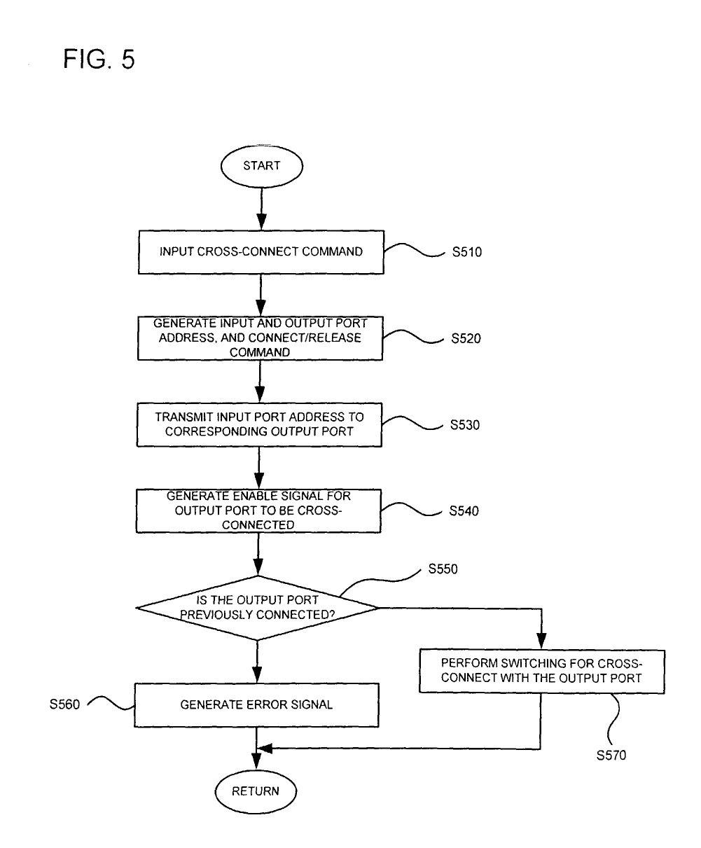

FIG. 5 is a flow chart illustrating a cross-connect control method of the DCS (digital cross-connect system) in accordance with the present invention. As shown, by operation of the operator, a cross-connect command for resetting cross-connect is input from the operating terminal 350 of the DCS to the command generation unit 300 of the cross-connect control apparatus of the present invention, as shown at step S510. The address processing module 310 of the command generation unit 300 then generates an address signal for indicating an input port and output port according to the cross-connect command and transmits it to the I/O port address reprocessing module 330. The command processing module 320 generates a connect/release request signal according to the cross-connect command and transmits it to the switching means 400 of each output port, as shown at step S520.

The connect/release request signal is output as a connect request signal for requesting connection between ports, or a connect release request signal for requesting connect release between ports according to the cross-connect command.

In the step S520, when a connect release command is generated, a connect release operation may be performed, for example, by the same method as that of the circuit distribution unit 120 of the conventional DCS.

The I/O port address reprocessing module 330 reprocesses the input port address from the address processing module 310 and transmits an input port address to be cross-connected to the switching means 400 of each output port, as shown at step S530. More specifically, in a 96×96 crosspoint switch, because there are ninety-six output ports, the I/O reprocessing module 330 generates ninety-six input port addresses to be transmitted to output ports #1˜#96.

When the pertinent input port address is received, according to the input port address (input address [6:0]), the output port address (output address [6:0]) and the connect request signal input into the switching means 400, the enable signal generating means 410 of the switching means 400 generates an enable signal (W_EN) for establishing cross-connect setting between the pertinent input port and the output port and transmits it to the analysis module 420, as shown at step S540.

The enable signal (W_EN) is for setting a new cross-connect. For example, when a W_EN#1 signal is set as 1 in the switching means allocated to the output port #1, the cross-connect to the output port #1 is set.

When the enable signal (W_EN) is received, the analysis module 420 judges whether the output port controlled by the pertinent switching means 400 is in a preset cross-connect state as shown at step S550. If the output port is in a preset cross-connect state, the analysis module 420 generates an error signal as shown at step S560. If the output port is not in a preset cross-connect state, it transmits a control signal (OUT_EN) and a latched input port address (input Latch_address [6:0]) to the switching unit 430, and accordingly a cross-connect between the pertinent output port and the designated input port is newly set, as shown at step S570.

When the error signal is generated, the cross-connect setting designated by the cross-connect command input through the operating terminal 350 is not performed. For example, when the control signal (OUT_EN#1) about the output port #1 is set as 1, among ninety-six input ports, an input port designated by the latched input port address (input Latch_address [6:0]) input from the analysis module 420 is connected to the output port #1. If the control signal (OUT_EN#1) about the output port #1 is set as 0, the output port #1 is set so as not to connect with any input port.

In order to check a cross-connect state, the analysis module 420 compares the inputW_EN#1 signal with the pre-stored OUT_EN#1 signal and then generates an error signal about the channel cross-connected with the output port #1. When the error signal is generated, the analysis module 420 maintains the existing latched input port address (input Latch_address [6:0]) and ignores the newly input port address (input address [6:0]).

If a newly applied cross-connect command requests a connect with an output port not connected with any input port (OUT_EN=0), because an error signal is 0 and an OUT_EN signal is 1, a latched input port address (input Latch_address [6:0]) is changed into a newly input input port address (input address [6:0]). Accordingly, if an I/O setting error occurs in a new cross-connect setting by the operator, the error can be detected through an error signal, and accordingly present servicing cross-connect information can be protected.

As described above, in the cross-connect control apparatus and the method thereof for the DCS in accordance with the present invention, when an I/O error occurs in a cross-connect command applied from the outside, by detecting an I/O error due to wrong cross-connect trial, it is possible to prevent a preset-cross-connect service from being interrupted.

In addition, in the cross-connect control apparatus for the DCS in accordance with the present invention, when a new cross-connect is set, by processing cross-connect information about a preset cross-connect by a hardware-like method, problems which occur in the conventional DCS due to discrepancies between software-like cross-connect information and a connect state of an actual unit can be solved. Accordingly, the present invention advantageously provides improved cross-connect service.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A cross-connect control apparatus for a B-DCS (broadband digital cross-connect system), comprising:
a cross-connect signal generating unit which generates signals for setting cross-connects according to input cross-connect commands; and
a switching unit connected to the output ports, and establishing cross-connects between the input ports and the output ports according to cross-connect signals from the cross-connect generating unit.

2. The apparatus of claim 1, wherein the cross-connect signal generating unit includes:
a command processing unit having a command processing module which generates a connect/release request signal and an address processing module which generates an input/output port address; and
an input/output port address reprocessing module which reprocesses the input/output port address generated by the address processing module.

3. The apparatus of claim 1, wherein the switching unit includes:
an enable signal generation module which generates an enable signal (W_EN) for cross-connect resetting based on an input port designated by an address processing module, an input port designated for an output port address, and an output port according to the connect/release request signal from the command processing module;
an analysis module which receives the enable signal (W_EN) from the enable signal generation module and judges whether a cross-connect between the input port and the output port is possible; and
a switching module which established a cross-connect between the input port and the output port according to a judging result of the analysis module.

4. The apparatus of claim 3, wherein the analysis module generates an error message when the output port is in a preset cross-connect state.

5. The apparatus of claim 3, wherein the analysis module does not perform cross-connect resetting when the output port is in a preset cross-connect state.

6. The apparatus of claim 3, wherein the analysis module performs the cross-connect when the pertinent output port is not in a preset cross-connect state.

7. A cross-connect control method for a B-DCS (broadband digital cross-connect system), comprising:
generating signals for resetting a cross-connect in a DCS (digital cross-connect system);
judging whether it is possible to perform the cross-connect between an input prot and an output port based on the signals; and
performing the cross-connect according to the judging result.

8. The method of claim 7, wherein the signal generating step includes:
receiving a cross-connect command;
generating an input/output port address and a connect/release request signal based on the cross-connect command; and
transmitting an input port address to be connected to the output port.

9. The method of claim 8, wherein the signal generating step includes:
generating an enable signal (W_EN) for indicating a cross-connect setting between the output port and the input port; and
judging whether the output port is in a preset cross-connect state based on the enable signal.

10. The method of claim 9, wherein the input port address transmitting step includes:
generating an error message when the output port is in the preset cross-connect state; and
establishing a cross-connect between the output port and the input port when the output port is not in the preset cross-connect state.

11. The method of claim 7, wherein the signal generating step includes:
generating an enable signal indicating a cross-connect setting between the output port and the input port based on the signals; and
judging whether the output port is in a preset cross-connect state based on the enable signal.

12. The method of claim 7, wherein the input port address transmitting step includes:
generating an error message when the output port is in the preset cross-connect state; and
establishing a cross-connect between the output port and the input port when the output port is not in the preset cross-connect state.

13. A cross-connect control method for a DCS (digital cross-connect system), comprising:
receiving a cross-connect command;
generating an input/output port address and a connect/release request signal based on the cross-connect command;
transmitting an input port address to be connected to an output port;
generating an enable signal (W_EN) indicating a cross-connect setting between the output port and the input port;
judging whether the output port is in a preset cross-connect state based on the enable signal;
generating an error message when the output port is in the preset cross-connect state; and
establishing a cross-connect between the output port and the input port when the output port is not in the preset cross-connect state.

14. A method for establishing signal paths in a switching system, comprising:
receiving a command for connecting one of a plurality of input ports to one of a plurality of output ports;
determining whether said one output port is in a preset connect state; and
suspending performance of the command if the output port is determined to be in said preset connect state.

15. The method of claim 14, wherein said switching system is included in a broadband digital cross-connect system.

16. The method of claim 14, further comprising:
outputting a warning signal if the output port is determined to be in said preset connect state.

17. The method of claim 14, further comprising:
establishing a connection between the input port and the output port if the output port is not in said preset connect state.

18. An apparatus for establishing signal paths in a switching system, said system including a plurality of input ports and at least one output port, said controller comprising:
an input unit which receives a command for connecting one of a plurality of input ports to the output port; and
a control unit which determines whether the output port is in a preset connect state; said control unit suspending performance of the command if the output port is determined to be in said preset connect state.

19. The apparatus of claim 18, wherein said switching system is included in a broadband digital cross-connect system.

20. The apparatus of claim 18, wherein the control unit outputs a warning signal if the output port is determined to be in said preset connect state.

21. The apparatus of claim 18, wherein the control unit establishes a connection between the input port and the output port if the output port is not in said preset connect state.

22. The apparatus of claim 18, wherein said system includes a plurality of output ports, and wherein said apparatus further comprises:
a plurality of switching modules connected to respective ones of the output ports, each switching module controlling connection of a respective output port to an input port based on a signal from the control unit.
